(19) United States
(12) Patent Application Publication
(10) Pub. No.: US 2018/0292633 A1
(43) Pub. Date: Oct. 11, 2018

(54) TERAHERTZ-GIGAHERTZ ILLUMINATOR

(71) Applicant: Archit Lens Technology Inc., Hsinchu City (TW)

(72) Inventors: Lawrence Dah-Ching Tzuang, Goleta, CA (US); Yen-Ju Wu, Sheffield (GB)

(21) Appl. No.: 15/481,559

(22) Filed: Apr. 7, 2017

(51) Int. Cl. G02B 19/00; G02B 26/08

(52) U.S. Cl. CPC G02B 19/0009; G02B 26/0875; G02B 19/009

(57) ABSTRACT

Terahertz-gigahertz illuminator that may be implemented in or attached to many gigahertz/terahertz applications or systems (such as imaging, security or communication system) is proposed. One or more THz emitters are combined to form an array, where each emitter is comprised of a THz source and a THz lens. Furthermore, for each THz emitter, the geometric relation between the THz source and the THz lens may be dynamically modified to dynamically modify both the emission angle and the pointing angle of the launched THz wave. In addition, each THz emitter may be rotated and/or translated to change the propagation direction of the launched THz wave. Therefore, the THz illuminator may uniformly illuminate the object of interest at any distance without modifying other aspects of the THz source to effectively use the limited source power provided by the individual THz emitters.

### FIELD OF THE INVENTION

The present invention relates to the terahertz-gigahertz (THz) illuminator, especially to the THz illuminator capable of effectively using the THz wave and improving the uniformity of the THz wave illuminating on the object(s).

### BACKGROUND OF THE INVENTION

The interest in THz technology has significantly increased during the past decades, and the commercial applications utilizing THz systems have stably increased as well. For example, both the THz imaging system and the THz security system have valuable commercial values because of its unique THz wave transmission properties. One classic example is the identification of concealed objects, such as a metal weapon hidden under a fiber cloth. Furthermore, due to the frequency of the THz waves, high bandwidth data carried by THz wave may enable future generations of communication systems.

The development of the THz technology has to confront some difficult challenges. One such challenge is that the commercial THz sources that are currently available are both relatively low power and expensive. For example, the output power of commercial THz sources are typically in the tens of milli-watt range, which is significantly lower than moderate performing light-emitting-diodes (LEDs) or even household light bulbs Hence, the designs and the applications of the THz system are clearly limited by the capability of the source. Furthermore, since the THz emission is not visible, how to effectively and uniformly illuminate the THz wave on one or more objects at any distance, but not elsewhere, is a difficult problem, especially if one or more of the amount of objects, the amount of the THz sources, and the geometric relations between the objects and the THz sources are constantly varying.

Therefore, it is required to provide a terahertz-gigahertz illuminator capable of effectively and uniformly illuminating the object(s) without wasting the output power of the THz source(s).

### SUMMARY OF THE INVENTION

The proposed invention of the terahertz-gigahertz illuminator (THz illustrator) uses one or more proposed THz emitters arranged in an array. Furthermore, both the distribution of these proposed THz emitters and the configuration within each proposed THz emitter are dynamically modifiable.

Essentially, the proposed THz emitter is composed of a THz source and a THz lens. In additional, a fixture is configured to hold both the THz source and the THz lens together. The THz source may be any well-known, on-developed or to-be-appeared THz source. The THz lens may be a single lens element or a set of lens elements that possesses THz wave converging power. For some examples, the THz source is placed on or close to the focal point of the THz lens such that the THz wave generated by the THz source will emit on the opposite side. The focal length of the THz lens should be small to collect as much THz wave as possible. For some examples, one or more of the THz source and the THz lens may be translated along the geometrical axis, defined as the line that crosses the geometric centers of both the THz lens and the THz source, so as to change the emission angle of the THz wave passing through the THz lens. For some examples, the THz source and/or the THz lens may be translated along a line vertical to and/or intersecting the geometrical axis so as to change the pointing angle of the THz wave launched from the THz emitter. For some examples, the THz source and/or the THz lens may be rotated, such as around a line intersecting the geometrical axis, so as to change the propagation direction of the launched THz wave. Herein, the emission angle is defined as the angular range of the THz wave launched from the THz emitter, and the pointing angle is defined as the angle between the center of the launched THz wave and the geometrical axis.

Essentially, the distributions of the THz emitters may be a single point (i.e., a zero-dimensional array), a one-dimensional array, a two-dimensional array, a three-dimensional array or others. For example, the emitters may be placed along a straight line, a curve or a zigzag. For example, the emitters may be distributed on a square, a circle, a polygon, a planar surface, a curved surface or an undulant surface. For examples, the emitters may be distributed as a two-dimensional array on the X-Y plane but at least two emitters having different positions along the Z axis. For example, the emitters may be regularly distributed or equally spaced for achieving better illumination uniformity.

### BRIEF DESCRIPTION OF THE DRAWINGS

FIG. 1A briefly illustrates a THz illuminator having some identical THz emitters, FIG. 1B briefly illustrates the configuration of the THZ emitter, FIG. 1C to FIG. 1D define the emission angle and the pointing angle of the THz wave launched by the THz emitter, and FIG. 1E to FIG. 1F briefly illustrate some THz emitters,

FIG. 2A and FIG. 2B briefly illustrate a THz illuminator having some similar THZ emitters arranged in a one-dimensional array wherein the emission angle of the launched THz waves is dynamically modified if the object distance is different, and FIG. 2C and FIG. 2D briefly illustrate how the distance between the THz source and the THz lens is dynamically modified by the internal driver inside the THz emitter to dynamically modify the emission angle.

FIG. 3A and FIG. 3B briefly illustrate a THz illuminator having some similar THZ emitters arranged in a two-dimensional array wherein the emission angle of the launched THz waves is different if the object distance is different, and FIG. 3C and FIG. 3D briefly present the illumination pattern and the relation between the emission angle and the object distance according to an example having four THz emitters, each with 1 Watt of power arranged in a one-dimensional array with a period of 40 cm.

FIG. 4A and FIG. 4B briefly illustrate a THz illuminator having some similar THz emitters arranged in a one-dimensional array wherein each of the THz emitters may dynamically modify its pointing angle respectively, and FIG. 4C briefly presents the illumination pattern according to an example having five THz emitters that each has 1 Watt of power and arranged in an one-dimensional array with a period of 40 cm for illuminating an object at 5 meters away.

FIGS. 5A and 5B briefly illustrate a THz illuminator having three THz emitters arranged in a one-dimensional array, and FIG. 5C to FIG. 5F briefly show how the three THz emitters are dynamically modified according to these mentioned steps.

FIG. 6 briefly illustrates the front view and the side view of a THz illuminator having sixteen THz emitters arranged in a 4×4 array, wherein these THz emitters are embedded in a common panel.

### DETAILED DESCRIPTION OF THE INVENTION

Reference will now be made in details to specific embodiment of the present invention. Examples of these embodiments are illustrated in the accompanying drawings. While the invention will be described in conjunction with these specific embodiments, it will be understood that the intent is not to limit the invention to these embodiments. In fact, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without at least one of these specific details. In other instances, the well-known portions are less or not described in detail in order not to obscure the present invention.

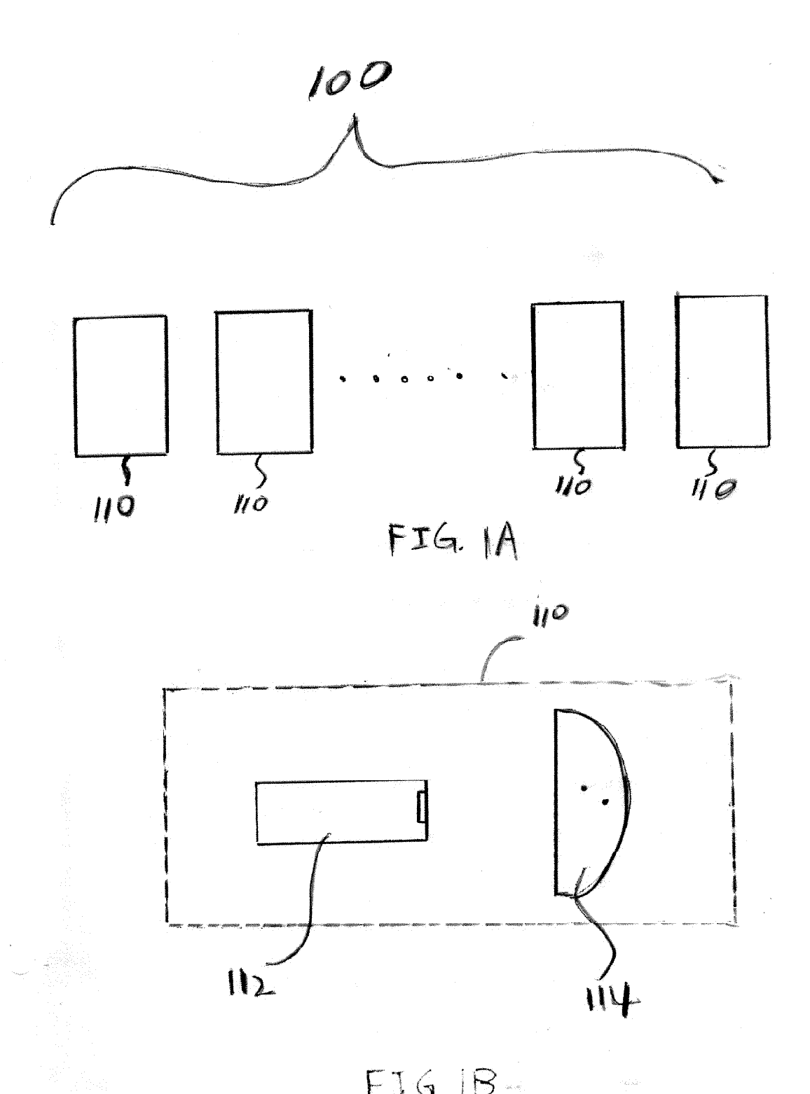

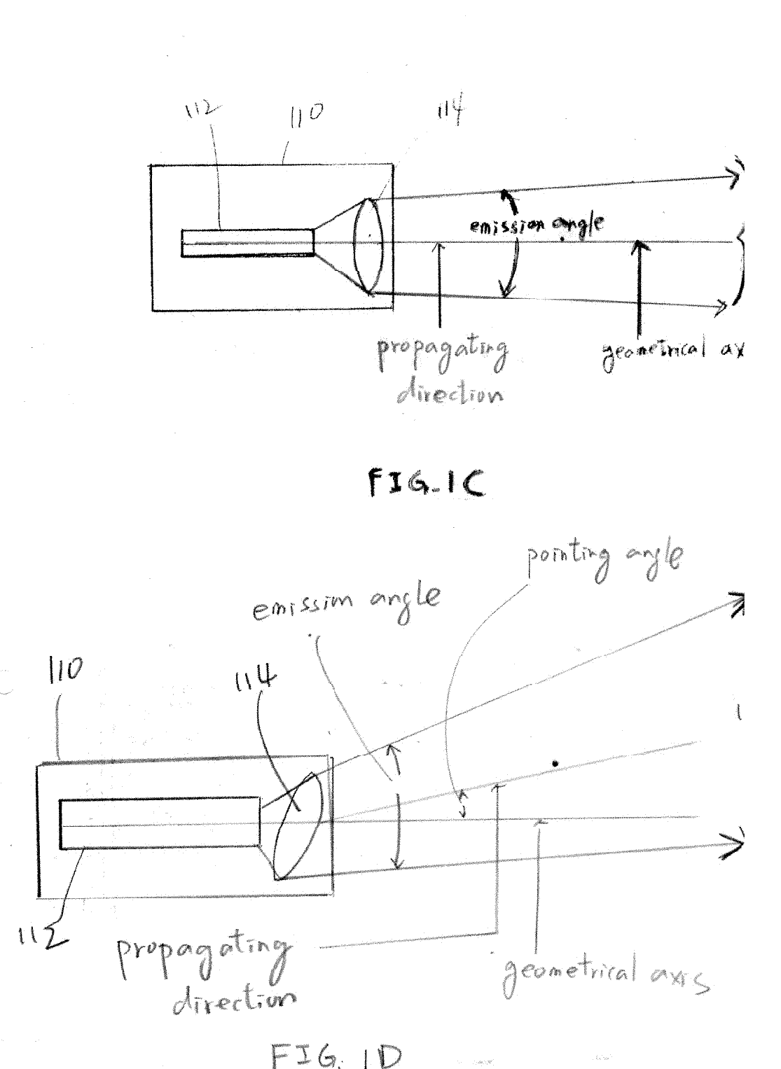

The proposed THz illuminator has one or more THz emitters and collectively uses the THz waves launched from the THz emitters, wherein the emitters may be dynamically modified independently according to the positions of the objects to be illuminated. Herein, FIG. 1A briefly illustrate the situation that a THz illuminator 100 having some identical THz emitters 110. As briefly illustrated in FIG. 1B, each THz emitter 110 has a THz source 112 and a THz lens 114, wherein the THz source 112 is placed on or close to the focal point of the THz lens 114 behind the THz lens 114. Both the emission angle and the pointing angle of the launched THz wave are defined in FIG. 1C and FIG. 1D. FIG. 1C shows the situation that the launched THz wave 199 is propagating along the geometrical axis defined as the line crosses the geometric centers of both the THz lens 114 and the THz source 112, which means that the pointing angle is zero. FIG. 1D shows the situation that the launched THz wave 199 is propagating along a direction intersecting the geometrical axis, which gives a non-zero pointing angle. As shown in FIG. 1E, for each THz emitter 110, an internal driver 116 may be used to translate and/or rotate one or more of the THz lens 114 and the THz source 112. In another example, as shown in FIG. 1F, for each THz emitter 110, an external driver 118 may be used to translate and/or rotate the entire THz emitter 110. In particular, to rotate the THz lens 114, the rotation axis is usually vertical to the geometrical axis of the THz lens 114. Significantly, by using one or more of the internal driver 116 and the external driver 118, for each THz emitter 110, both of its emission angle and pointing angle of the launched THZ wave may 199 be dynamically modified.

In general, the THz lens 114 can be single element or formed by multiple lens elements, and the THz source 112 is placed on the focal point of the THz lens 114 such that the THz wave generated by the THz source 112 will emit on the opposite side. Thus, the THz wave generated by the THz source 112 transmits through the THz lens 114 and illuminates an object with a finite size at a finite distance. Moreover, to avoid diffraction and to ensure that small emission angle can be achieved, the diameter of the THz lens 114 usually is at least 5 to 10 times of the wavelength of the THz wave generated by the THz source. For example, if the THz illuminator 100 is designed for the THz wave with frequency at 100 GHz, a 30 mm minimum lens diameter is necessary. For example, a 10 times ratio will result in a minimum emission angle of about 5 degrees limited by diffraction. However, a larger diameter of THz lens 114 may be disadvantageous because of the material cost, size, and weight. Moreover, the thickness of the THz lens 114 is not limited, although a thinner THz lens 114 is preferred because of lower material cost, less THz wave absorption, and ease of manufacturing.

Furthermore, the performance of the THz lens 114, even the performance of any lens element of the THz lens 114, may be similar with the performance of at least one of the following: a plano-convex lens, a plano-concave lens, a convex-convex lens and a convex-concave lens. Besides, for each lens element, the non-planar surface may be spherical or aspherical, although aspherical surface may be more useful for reducing the lens thickness.

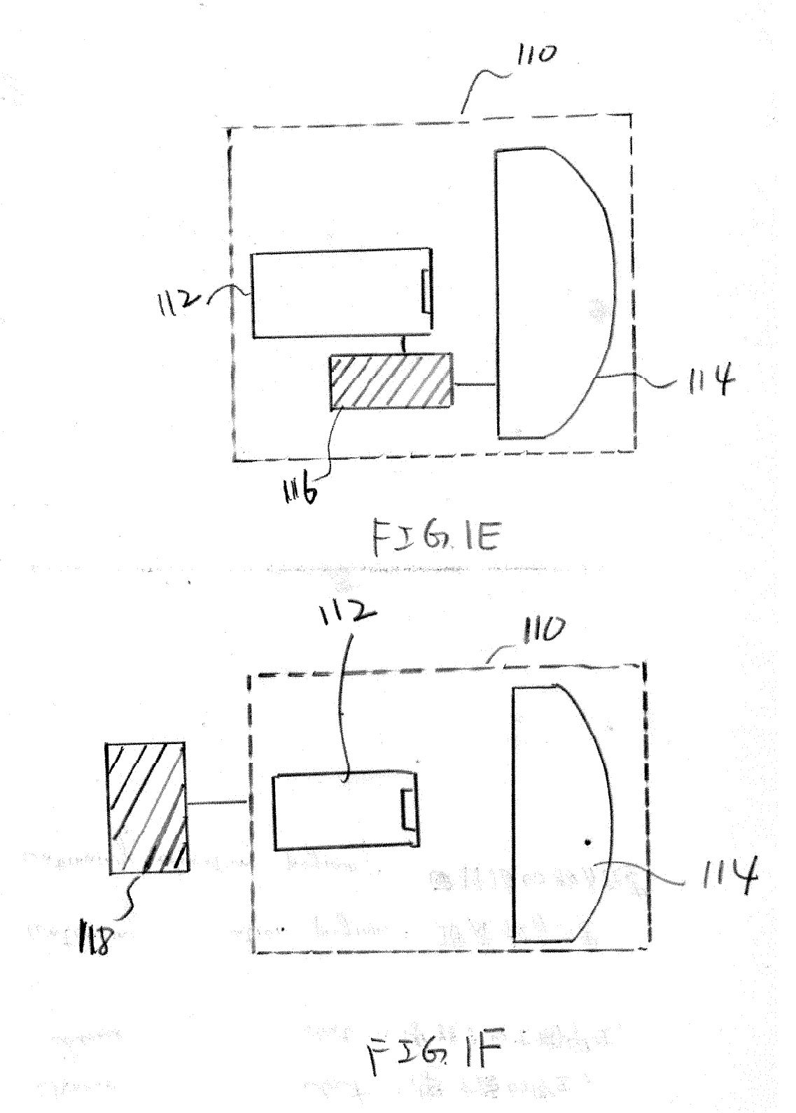

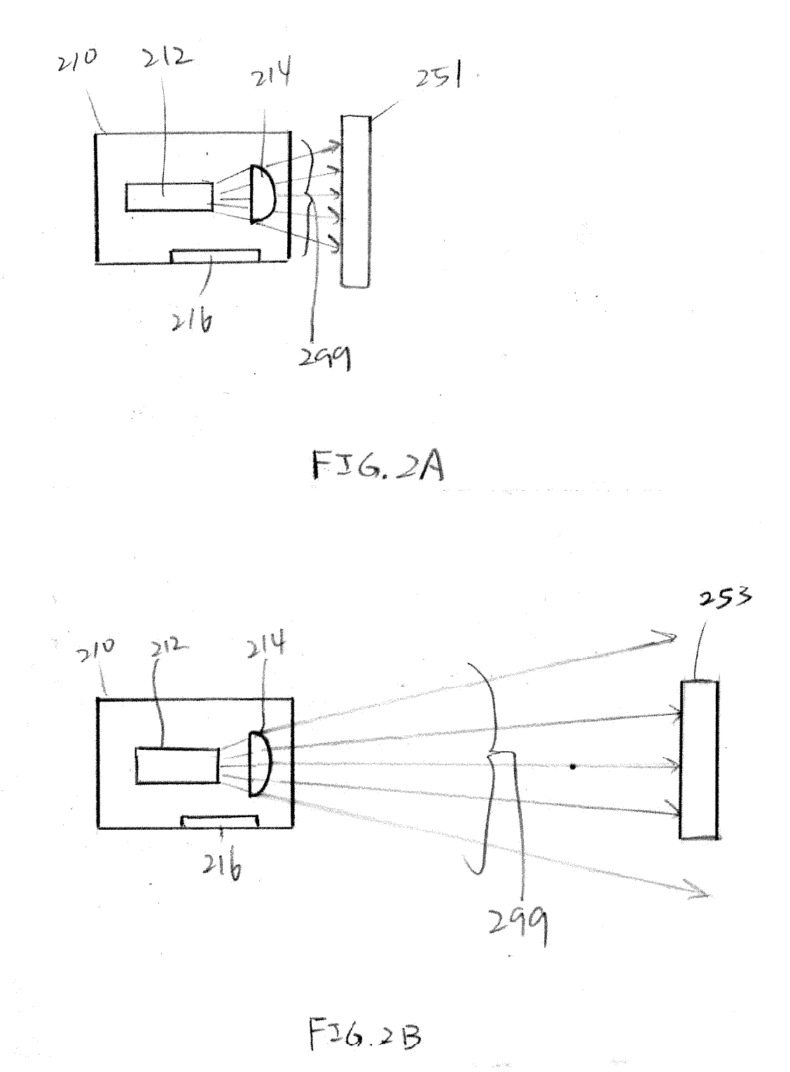

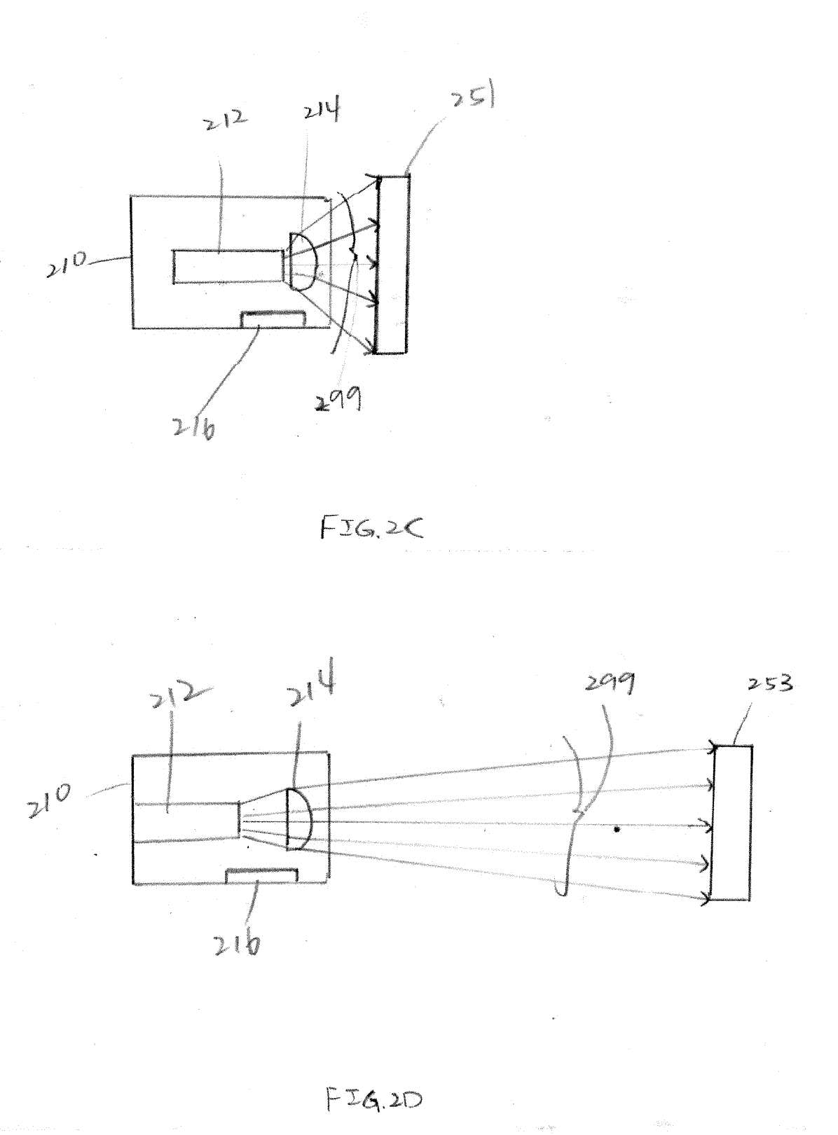

Some embodiments of the proposed invention are briefly illustrated in FIG. 2A to FIG. 2D and related to the THz illuminator 200 having one and only one THz emitter 210 (or viewed as a zero-dimensional array) with a fixed pointing angle. In these embodiments, if the distance between the THz source 212 and the THz lens 214 is fixed, the emission angle of the launched THz wave 299 is fixed accordingly. Thus, the launched THz wave 299 may not properly illuminate the object 251/253 if the size of object 251/253 is different than the beam width of the launched THz wave 299 arriving at object 251/253. However, by using the internal driver 216 to change the geometric relation between the THz lens 214 and the THz source 212, these embodiments may dynamically modify the emission angle of the launched THz wave 299 (or viewed as may change the beam width of the launched THz wave 299 on objects 251/253) to cover the entire object 251/253. Hence, at least the disadvantages that portions of the object 251 are not illuminated by the launched THZ wave 299 may be minimized. In summary, these embodiments may effectively use the THz wave 299 generated by the THz source 212 by properly illuminating the objects 251/253.

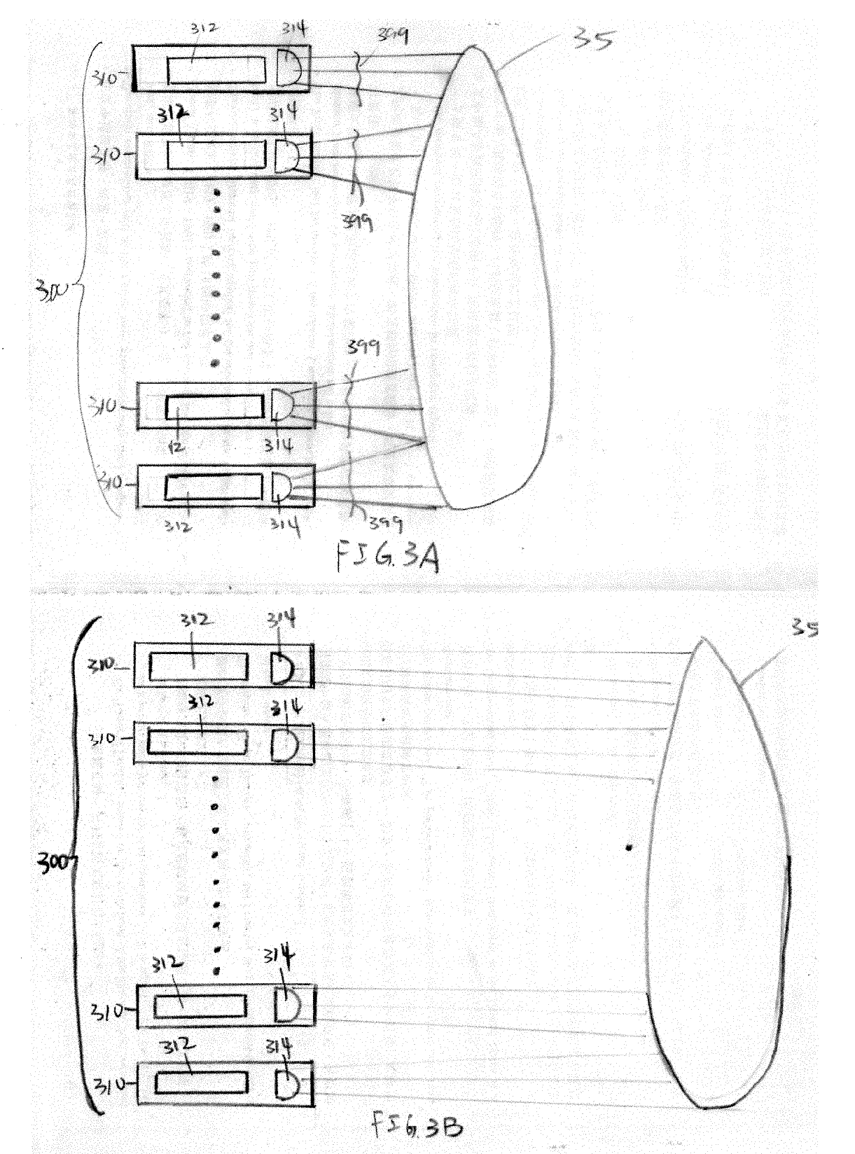

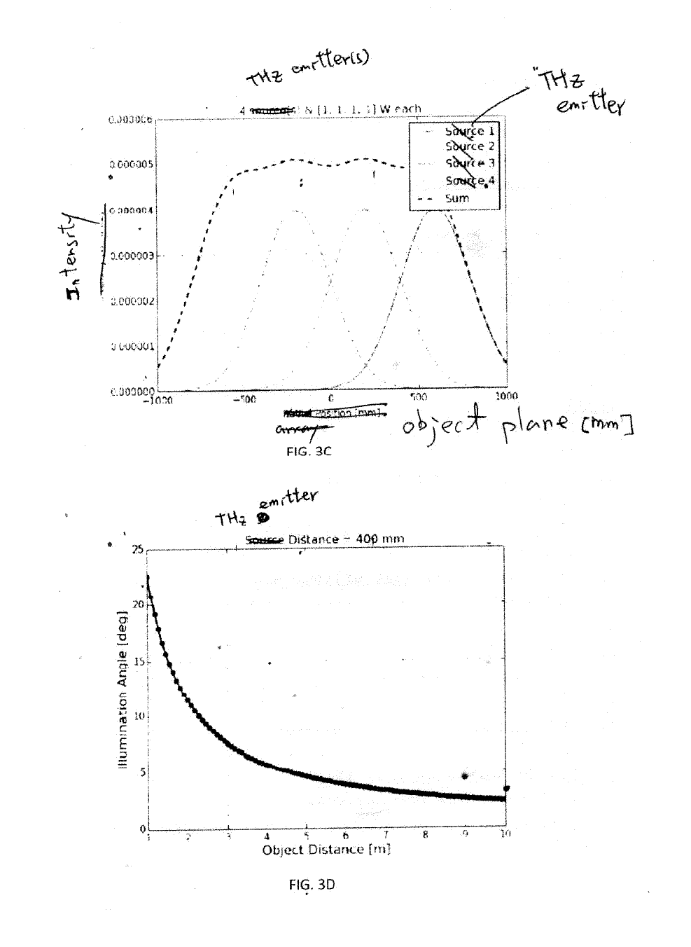

Some embodiments of the proposed invention are briefly illustrated in FIG. 3A and FIG. 3B and are related to the THz illuminator 300 having some identical THz emitters 310 with fixed pointing angle and arranged in an equally-spaced one-dimensional array. In these embodiments, to efficiently use the individual THz emitters 310 and uniformly illuminate the object 35 at any distance from the THz illuminator 300, these THZ emitters 310 should have identical emission angles of the launched THz wave such that the area of the illumination remains constant at about the size of the array for any object distances when operating collectively. For example, by assuming each THz emitter 310 illuminates the THz waves 399 with a Gaussian profile, each THz emitter 310 may have an identical emission angle defined as 2*tan⁻¹(0.5*period/(object distance)), wherein the period is the spacing of the THz emitter array 300. In other words, whenever the object distance is determined, all THz emitters 310 may be dynamically modified to have the required emission angle of the launched THz wave 399 to uniformly illuminate the object. To provide a specific example, as shown in FIG. 3C, the illumination pattern of four THz emitters 310 each having 1 W (one Watt) of power are arranged in a straight line on the illumination plane with a period of 40 cm. If the emission angle for all the THz emitters 310 are dynamically modified correctly, the illumination profile is uniform along the axis of the illumination plane. Furthermore, as shown in FIG. 3D, depending on the object distance, the emission angle of each THz emitter is varied accordingly. In summary, the internal driver may be used to dynamically modify the distance between the THz source 312 and the THz lens 314 according to the object distance of the object to be illuminated.

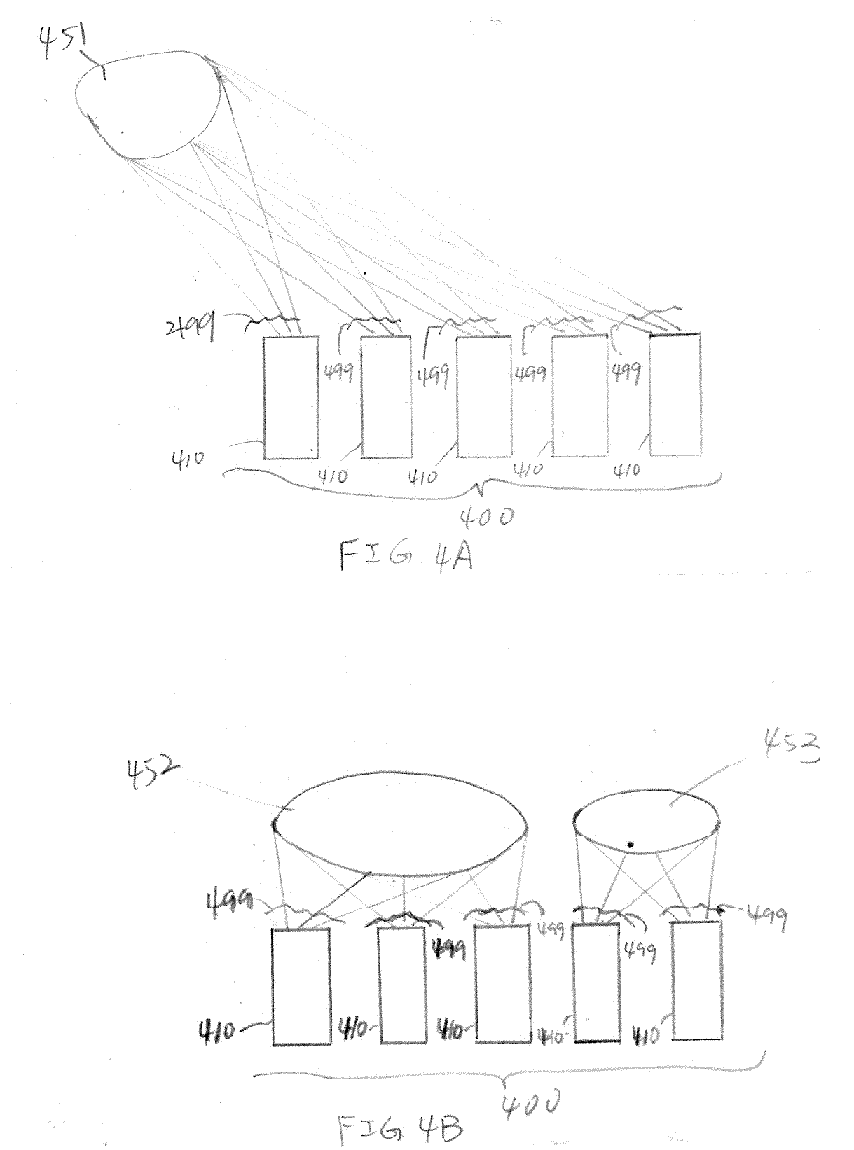

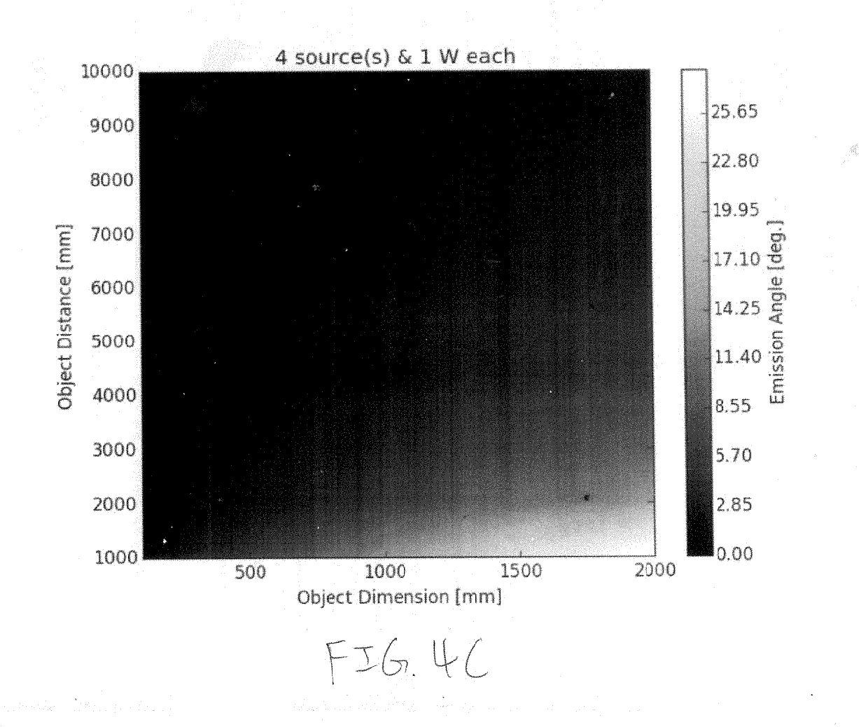

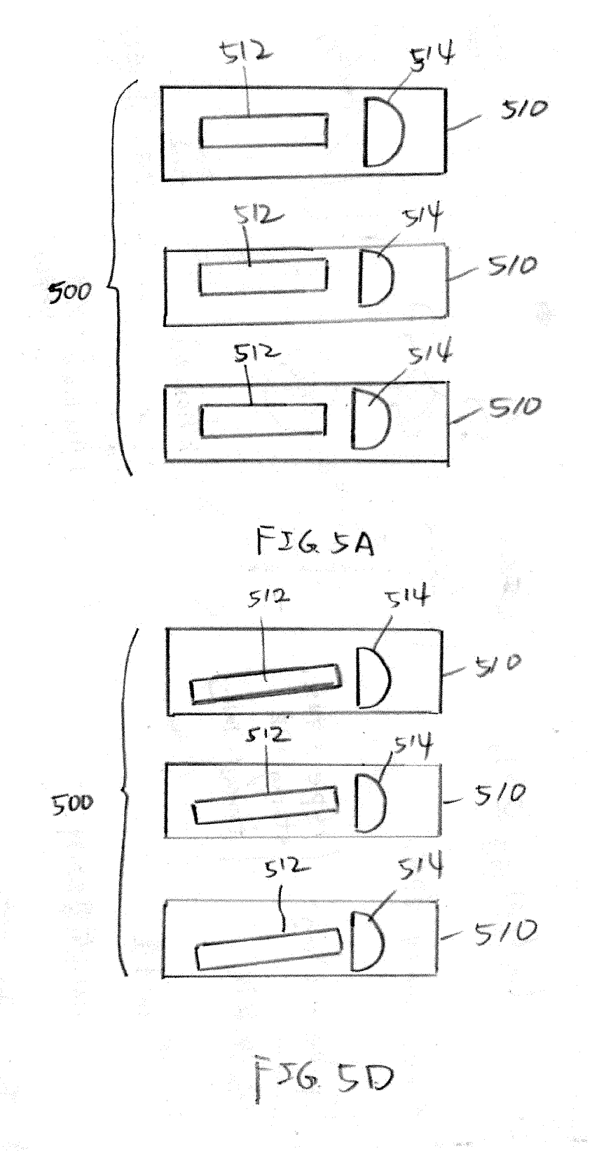

Some embodiments of the proposed invention are briefly illustrated in FIG. 4A and FIG. 4B and are related to the THz illuminator 400 having some similar THz emitters 410 arranged in a one-dimensional array. In these embodiments, each of the THz emitters 410 may dynamically modify both their pointing and emission angles, and then the THz emitters 410 may collectively illuminate the objects 451/452/453 of any size and at any object distance efficiently. Both the pointing angle and the emission angle for each THz emitter 410 is dynamically modified to a particular combination such that the THz wave 499 launched from the dynamically modified THz emitters 410 cover, and only cover, objects 451/452/453. For example, by assuming each THz emitter 410 is equally spaced and illuminates THz waves 499 with a Gaussian profile, each THz emitter 410 may have the same emission angle defined as 2*tan⁻¹(0.5*FWHM/(object distance)), wherein the FWHM is the full-width-half-max of the illumination on the object. To uniformly illuminate the object using all THz emitters 410 collectively, the FWHM equals to the desired area of illumination divided by the axial number of the THz emitters 410. For each individual THz emitter 410, to modify the pointing angle, an internal driver may be used to change the relative position between the THz source and the THz lens. The internal driver may also be used to rotate one or more of the THZ lens and the THz source, even an external driver may be used to translate and/or rotate the THz emitter 410, to dynamically modify the pointing angle. The pointing angle of the Xₜₕ row (or column) or the THz emitter 410 in the THz illuminator 400 is defined as tan⁻¹(((array period)*(0.5*(ANOS)−1)−X)/((FWHW)*(0.5*(ANOS)−1)−X)), wherein ANOS is the axial number of the THZ emitters 410. For example, as shown in FIG. 4C, the example illumination pattern of five THz emitters 410 having 1 W (one Watt) power individually and arranged in an one-dimensional array on the illumination plane with a period of 40 cm for illuminating an object 45 at 5 meters away is shown in FIG. 4E. Obviously, the illumination profile is uniform along the axis of the array of the five THz emitters 410.

Significantly, as mentioned in these embodiments described above, the invention has two key features. First, for each THz emitter, the geometric relation between the THz source and the THz lens is dynamically modifiable such that one or more of the emission angle and even the pointing angle, of the launched THz wave may be dynamically modified. Second, for some THZ emitters arranged in an array, different THz emitters may be dynamically modified independently such that the THz waves launched from these THZ emitters may effectively and uniformly illuminate the object(s) in different object position(s). Accordingly, the invention does not limit other details if the two key features mentioned above can be achieved.

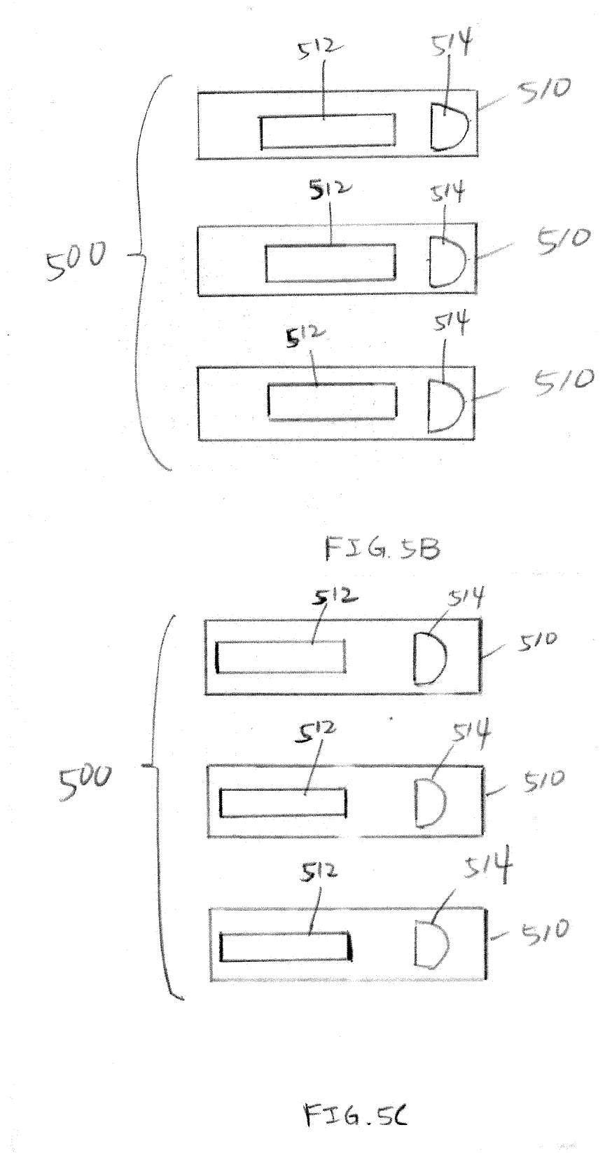

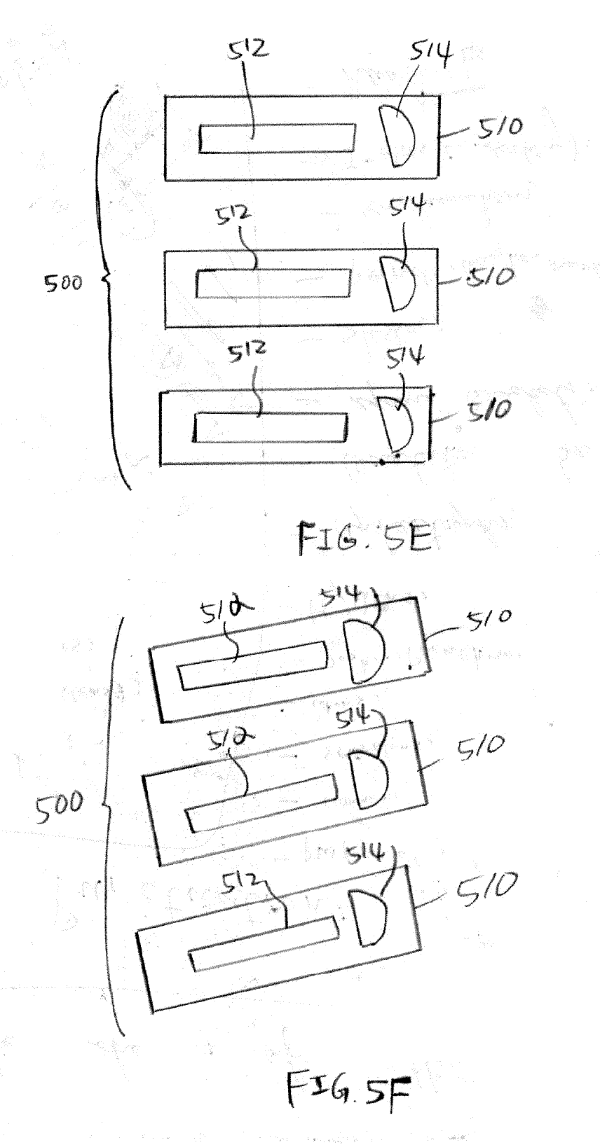

For example, for each THz emitter, the geometric relation between the THz source and the THz lens may be changed by at least one of the following steps: translating the THz source along the geometrical axis, translating the THz lens along the geometrical axis, translating the THZ source along a line (straight line or curve or zigzag or others) vertical to or intersecting the geometrical axis, translating the THz lens along a line (straight line or curve or zigzag or others) vertical to or intersecting the geometrical axis, rotating the THz lens around an axis vertical to or intersecting the geometrical axis, and rotating the THz source around an axis vertical to or intersecting the geometrical axis of the THz lens. For example, for these THz emitters arranged in an array, both the pointing angle and the emission angle of the THz waves launched from these THz emitters may be dynamically modified by at least one of the following steps: freely rotating at least one THz emitter without changing the geometric relation between the THz source and the THz lens inside the rotated THz emitter, freely translating at least one THz emitter without changing the geometric relation between the THz source and the THz lens inside the translated THz emitter, and changing the geometric relation between the THz source and the THz lens inside at least one THz emitter. Just for examples, FIG. 5A briefly illustrate a THz illuminator having three THz emitters arranged in a one-dimensional array, and FIG. 5B to FIG. 5F briefly how the three THz emitters are dynamically modified according to these steps mentioned above respectively. Herein, the THz illuminator is labeled as 500, the THz emitter is labeled as 510, the THz source is labeled as 512, and the THz lens is labeled as 514.

As a short summary, for each THz emitter 510, the emission angle of the emitted THz wave may be modified by one or more of the following: translate the THz lens 514 along the geometrical axis and translate the THz source 512 along the geometrical axis. Further, the pointing angle of the emitted THz wave may be modified by one of more of the following: rotate the THz lens 514 around a direction vertical to or intersecting the geometrical axis, rotate the THz source 512 around a direction vertical to or intersecting the geometrical axis, translate the THz lens 514 along a direction vertical to or intersecting the geometrical axis, translate the THz source 512 along a direction vertical to or intersecting the geometrical axis, and rotate the THz emitter 510 around a direction vertical to or intersecting the geometrical axis.

Further, in general, the rotation angle is equal to or smaller than 45 degrees to ensure that most THz waves dynamically modified by the THz lens 514. Moreover, in general, the distance between the THz source 512 and the THz lens 514 is equal to or smaller than the focal length (or the effective focal length) of the THz lens 514 to ensure that at most of the THz waves launched from the THz source 512 may dynamically modified transmit through the THz lens 512. Therefore, in several examples, the inner driver may be designed to translate the THz lens along the geometrical axis or a direction intersecting the geometrical axis, wherein the distance between the THz lens and the THz source along the geometrical axis is maintained to be equal to or smaller than the radius of the THz lens. In several examples, the inner driver may be designed to translate the THz source along the geometrical axis or a direction intersecting the geometrical axis, wherein the distance between the THz lens and the THz source along the geometrical axis is maintained to be equal to or smaller than the radius of the THz lens. In several examples, the inner driver may be configured to rotate the THz lens around an axis intersecting the geometrical axis wherein the rotation angle is equal to or small than 45 degrees, or may be configured to rotate the THz lens around an axis vertical to the geometrical axis wherein the rotation angle is equal to or small than 45 degrees. Also, in several examples, the inner driver may be configured to rotate the THz source around an axis intersecting the geometrical axis wherein the rotation angle is equal to or small than 45 degrees, or may be configured to rotate the THz sources around an axis vertical to the geometrical axis wherein the rotation angle is equal to or small than 45 degrees. Again, in several examples, the external driver may also be configured to rotate the THz emitter around an axis intersecting the geometrical axis wherein the rotation angle is equal to or smaller than 45 degrees, or may be configured to rotate the THz emitter around an axis vertical to the geometrical axis wherein the rotation angle is equal to or smaller than 45 degrees.

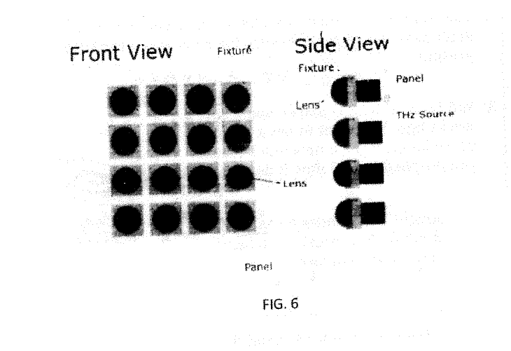

Furthermore, although only zero-dimensional and one-dimensional array are illustrated in the above embodiments, the invention may also arrange a plurality of THz emitters in a two-dimensional array or a three-dimensional array. Furthermore, the details of the array are not limited. For example, the zero-dimensional array is a single point, which means only one THz emitter is used. For example, if two or more THz emitters are used, the one-dimensional array may be a straight line, a curve or a zigzag, and the two-dimensional array may be a square, a circle, a polygon, a planar surface, a curved surface, a smooth surface or an undulant surface. For example, for the three-dimensional array, the two or more THz emitters may be distributed as the two-dimensional array discussed above on the X-Y plane but at least two THz emitters having different positions along the Z axis. Furthermore, to effectively and uniformly illuminate the object(s), it is beneficial but not mandatory to place the THz emitter(s) in equal spacing. Herein, FIG. 6 briefly illustrates the front view and the side view of a THz illuminator having sixteen THz emitters arranged in a two-dimensional 4×4 array, wherein these THz emitters are embedded in a common panel.

One of the advantages of the proposed THz illuminator is that the required size of the THz lens is reasonably small because each THz source pairs with an independent THz lens. Due to the longer wavelength of the THz wave and the poor power performance for the THz sources, the usage of multiple THz sources will become prevalent and the size of the combined source will become larger. Therefore, using a number of small THz lenses can be potentially cheaper and lighter than the usage of a few large THz lenses.

In addition, to minimize the size for providing a compact and portable THz illuminator, each THz emitter may be immediately adjacent to the neighboring THZ emitter(s). Also, to match the pre-determined illuminator's operation environment or to match the potential distribution range of the size(s) and the position(s) of the object(s), it is at times beneficial that each THz emitter is separated with other THz emitters.

Furthermore, the material of the THz lens (or viewed as the material of each lens element) may be glass, quartz, or any other material being transparent for the THz wave. Besides, the details of both the internal driver and the external driver are not limited, too. For example, a combination of motor(s) and mechanical structure(s) may be used to translate one or more of the THz source and the THz lens for dynamically modifying the distance between them, and a linear actuator may be used to translate the THz emitter, and a rotary actuator may be used to rotate the THz emitter. In addition, to further improve the quality of the THz wave launched from the THz emitter, it is optional that at least a portion of the THz lens is coated by an anti-reflection layer or at least a portion of one or more lens elements are coated by an anti-reflection layer and it is also optional that at least a portion of the surface of the fixture for holding both the THz lens and the THz source is coated (or covered) by an anti-reflecting absorbing layer. Herein, the anti-reflecting absorbing layer may be made of any material capable of both absorbing the THz wave and minimizing reflection of the THz wave launched from the THz source. Just for example, the anti-reflection absorbing layer may be made of Expandable Polypropylene (EPP), even EPP doped with carbon particles, sliver particles or other conductive particles.

Although the embodiments described above use some identical THz emitters collectively to build the THz illuminator, the proposed invention may also use different THz emitters to build the THz illuminator. In other words, the proposed invention may use different THz emitters having different THz lens and/or different THz sources, although the dynamically modify of the THz illuminator built by different THz emitters usually is more complex than the dynamically modify of the THz illuminators built by identical THz emitters. For example, different THz emitters having different THz lens may require different geometric relations between the THz lens and the THz source to obtain similar (even identical) emission or pointing angle of the THz wave launched from each of the THz emitters.

The applications of the proposed THz illuminator may be briefly described below. In the case that the THz illuminator is embedded in a THz imaging system, a device that detects the object's distance (for example, a depth imager or a radar system) and a THz illuminator may be used together. The role of the depth imager or a radar system is to find the position of the object of interest. Then, the THz illuminator reacts accordingly such that the THz waves may focus on the object of interest such that it uniformly and efficiently illuminates on only the object of interest. This way results in improved signal-to-noise-ratio of the THz imaging system.

The presently disclosed embodiments should be considered in all respects to be illustrative and not restrictive. The scope of the invention is indicated by the appended claims rather than the foregoing description, and all variation which come within the meaning and range of equivalents thereof are intended to be embraced therein.

What is claimed is:

1. A terahertz-gigahertz illuminator, comprising:
a THz emitter having a THz source and a THz lens;
wherein one or more of both the emission angle and the pointing angle of the THZ emitter are dynamically modifiable;
wherein the emission angle is defined as the angular range of the THz wave launched from the THz emitter;
wherein the pointing angle is defined as the angle between the center of the launched THz wave and the geometrical axis defined as the line that crosses the geometric centers of both the THz lens and the THz source.

2. The terahertz-gigahertz illuminator as claimed in claim 1, wherein the diameter of the THz lens is at least five to ten times of the wavelength of the THz wave generated by the THz source.

3. The terahertz-gigahertz illuminator as claimed in claim 1, wherein the THz lens is a single lens element or a combination of multiple lens elements.

4. The terahertz-gigahertz illuminator as claimed in claim 3, wherein the at least a surface of at least a lens element is spherical or aspherical.

5. The terahertz-gigahertz illuminator as claimed in claim 3, wherein the performance of at least a THz lens is similar with the performance of at least one of the following: a plano-convex lens, a plano-concave lens, a convex-convex lens and a convex-concave lens.

6. The terahertz-gigahertz illuminator as claimed in claim 1, wherein the THz source is placed on or near the focal point of the THz lens such that the THz wave generated by the THz source will emit on the opposite side.

7. The terahertz-gigahertz illuminator as claimed in claim 1, further comprising at least one of the following:
an inner driver configured to translate the THz source along the geometrical axis; and
an inner driver configured to translate the THz lens along the geometrical axis.

8. The terahertz-gigahertz illuminator as claimed in claim 1, further comprising at least one of the following:
an inner driver configured to rotate the THz lens; and
an inner driver configured to rotate the THz source.

9. The terahertz-gigahertz illuminator as claimed in claim 1, further comprising an external driver configured to rotate and/or translate the entire THz emitter without changing the geometric relation between the THz source and the THz lens.

10. The terahertz-gigahertz illuminator as claimed in claim 7, further comprising at least one of the following:
the inner driver is configured to translate the THz lens along the geometrical axis wherein the distance between the THZ lens and the THz source is maintained to be equal to or smaller than the radius of the THz lens;
the inner driver is configured to translate the THz lens along a direction intersecting the geometrical axis wherein the distance between the THZ lens and the THz source is maintained to be equal to or smaller than the radius of the THz lens;
the inner driver is configured to translate the THz source along the geometrical axis wherein the distance between the THZ lens and the THz source is maintained to be equal to or smaller than the radius of the THz lens;
the inner driver is configured to translate the THz source along a direction interesting the optical wherein the distance between the THZ lens and the THz source is maintained to be equal to or smaller than the radius of the THz lens;
the inner driver is configured to rotate the THz lens around an axis intersecting the geometrical axis of the THz lens, wherein the rotation angle is equal to or small than 45 degrees;
the inner driver is configured to rotate the THz lens around an axis vertical to the geometrical axis of the THz lens, wherein the rotation angle is equal to or smaller than 45 degrees;
the inner driver is configured to rotate the THz source around an axis intersecting the geometrical axis of the THz lens, wherein the rotation angle is equal to or smaller than 45 degrees;
the inner driver is configured to rotate the THz source around an axis vertical to the geometrical axis of the THz lens, wherein the rotation angle is equal to or smaller than 45 degrees;
the external driver is configured to rotate the THz emitter around an axis intersecting the geometrical axis of the THz lens, wherein the rotation angle is equal to or smaller than 45 degrees; and
the external driver is configured to rotate the THz emitter around an axis vertical to the geometrical axis of the THz lens, wherein the rotation angle is equal to or smaller than 45 degrees.

11. The terahertz-gigahertz illuminator as claimed in claim 8, further comprising at least one of the following:
the inner driver is configured to translate the THz lens along the geometrical axis wherein the distance between the THZ lens and the THz source is maintained to be equal to or smaller than the radius of the THz lens;
the inner driver is configured to translate the THz lens along a direction intersecting the geometrical axis wherein the distance between the THZ lens and the THz source is maintained to be equal to or smaller than the radius of the THz lens;
the inner driver is configured to translate the THz source along the geometrical axis wherein the distance between the THZ lens and the THz source is maintained to be equal to or smaller than the radius of the THz lens;
the inner driver is configured to translate the THz source along a direction interesting the optical wherein the distance between the THZ lens and the THz source is maintained to be equal to or smaller than the radius of the THz lens;
the inner driver is configured to rotate the THz lens around an axis intersecting the geometrical axis of the THz lens, wherein the rotation angle is equal to or small than 45 degrees;
the inner driver is configured to rotate the THz lens around an axis vertical to the geometrical axis of the THz lens, wherein the rotation angle is equal to or smaller than 45 degrees;
the inner driver is configured to rotate the THz source around an axis intersecting the geometrical axis of the THz lens, wherein the rotation angle is equal to or smaller than 45 degrees;
the inner driver is configured to rotate the THz source around an axis vertical to the geometrical axis of the THz lens, wherein the rotation angle is equal to or smaller than 45 degrees;
the external driver is configured to rotate the THz emitter around an axis intersecting the geometrical axis of the THz lens, wherein the rotation angle is equal to or smaller than 45 degrees; and
the external driver is configured to rotate the THz emitter around an axis vertical to the geometrical axis of the THz lens, wherein the rotation angle is equal to or smaller than 45 degrees.

12. The terahertz-gigahertz illuminator as claimed in claim 9, further comprising at least one of the following:
the inner driver is configured to translate the THz lens along the geometrical axis wherein the distance between the THZ lens and the THz source is maintained to be equal to or smaller than the radius of the THz lens;
the inner driver is configured to translate the THz lens along a direction intersecting the geometrical axis wherein the distance between the THZ lens and the THz source is maintained to be equal to or smaller than the radius of the THz lens;
the inner driver is configured to translate the THz source along the geometrical axis wherein the distance between the THZ lens and the THz source is maintained to be equal to or smaller than the radius of the THz lens;
the inner driver is configured to translate the THz source along a direction interesting the optical wherein the distance between the THZ lens and the THz source is maintained to be equal to or smaller than the radius of the THz lens;
the inner driver is configured to rotate the THz lens around an axis intersecting the geometrical axis of the THz lens, wherein the rotation angle is equal to or small than 45 degrees;
the inner driver is configured to rotate the THz lens around an axis vertical to the geometrical axis of the THz lens, wherein the rotation angle is equal to or smaller than 45 degrees;
the inner driver is configured to rotate the THz source around an axis intersecting the geometrical axis of the THz lens, wherein the rotation angle is equal to or smaller than 45 degrees;
the inner driver is configured to rotate the THz source around an axis vertical to the geometrical axis of the THz lens, wherein the rotation angle is equal to or smaller than 45 degrees;
the external driver is configured to rotate the THz emitter around an axis intersecting the geometrical axis of the THz lens, wherein the rotation angle is equal to or smaller than 45 degrees; and
the external driver is configured to rotate the THz emitter around an axis vertical to the geometrical axis of the THz lens, wherein the rotation angle is equal to or smaller than 45 degrees.

13. The terahertz-gigahertz illuminator as claimed in claim 1, further comprising at least one of the following:
one or more lens element(s) of the THz lens is coated by an anti-reflection layer; and
at least a portion of the inner surface of the THz lens fixture for holding both the THz lens and the THz source is coated by an anti-reflecting absorbing layer

14. The terahertz-gigahertz illuminator as claimed in claim 1, further comprising two or more THz emitters placed on a one-dimensional array, a two-dimensional array or a three-dimensional array.

15. The terahertz-gigahertz illuminator as claimed in claim 14, further comprising at least one of the following:
the one-dimensional array is chosen from a group of the following: a straight line, a curve, or a zigzag; and
the two-dimensional array is chosen from a group of the following: a circle, a polygon, a planar surface, a curved surface, and an undulant surface.

16. The terahertz-gigahertz illuminator as claimed in claim 14, wherein the individual THz emitters may be modified to launch THz waves with the same emission angle and the same pointing angle.

17. The terahertz-gigahertz illuminator as claimed in claim 14, further comprising at least one of the following:
at least two THz emitters may be dynamically modified to launch THz waves with different emission angle; and
at least two THz emitters may be dynamically modified to launch THz waves with different pointing angles.

18. The terahertz-gigahertz illuminator as claimed in claim 14, wherein the geometric relation between the THz source and the THz lens of at least one THz emitter may be dynamically modifiable.

19. The terahertz-gigahertz illuminator as claimed in claim 14, further comprises at least one of following:
at least one THz emitter may be freely rotated;
at least one THz emitter may be freely translated; and
at least two THz emitters may dynamically modify one or more of the emission angle and the pointing angle of the launched THz waves.

20. The terahertz-gigahertz illuminator as claimed in claim 14, further comprising at least one of the following:
the THz emitters are regularly distributed over the entire array; and
the THz emitters are equally spaced over the entire array.
